(19) United States
(12) Patent Application Publication
(10) Pub. No.: US 2004/0127823 A1
(43) Pub. Date: Jul. 1, 2004

(54) Seat with massage mechanism

(75) Inventors: Masatoshi Mori, Anjo-shi (JP); Shingo Fujiwara, Kariya-shi (JP); Shigeyuki Maezuru, Kariya-shi (JP)

Correspondence Address: OLIFF & BERRIDGE, PLC, P.O. BOX 19928, ALEXANDRIA, VA, 22320, US

(73) Assignee: ARACO KABUSHIKI KAISHA, Toyota-shi (JP)

(21) Appl. No.: 10/624,648

(22) Filed: Jul. 23, 2003

(30) Foreign Application Priority Data
Jul. 31, 2002 (JP) 2002-223246

(51) Int. Cl. A61H 15/00

(52) U.S. Cl. 601/99

(57) ABSTRACT

A seat with a massage mechanism includes recessed sections at flanges on opposite sides of a base frame. Screw-nut mechanisms are arranged along the opposite sides, in which brackets are fixed to nuts and a rod is held by links supported by the brackets. The rod includes push rollers. The rod moves vertically along guide sections and is retracted in the recessed sections. In the recessed sections, the rod and the push rollers do not receive the weight of a sitter.

### BACKGROUND OF THE INVENTION

The present invention relates to a seat with a massage mechanism, and more particularly, to a seat with a massage mechanism adapted to be applicable to a vehicle seat.

A vehicle seat with a massage mechanism is generally known in which the massage mechanism is operated to push the lumber of a person sat on the seat thereby recovering himself/herself from fatigue.

For example, JP-A-4-126106/1992 describes a structure in which a rotatable crank rod is disposed between side frames of the seat, and a roller having a large number of projections is mounted to an eccentric part of the crank rod. In this example, when the crank rod is rotated by an electric motor, the rotatable roller mounted to the eccentric part of the crank rod moves back and forth relative to the seat in plan view. As the roller moves forward, it pushes the lumber or the like of the person sat on the seat.

Accordingly, the person sitting in the seat or the sitter periodically receives local pressure (finger pressure) by the projections of the roller, thus recovering from fatigue. The seats of vehicles have a pad layer, or a urethane layer, with a certain thickness inside the skin, and the massage mechanism arranged behind the urethane layer.

Therefore, the local pressure by the projections of the roller is applied to the sitter, or the user, through the urethane layer, so that the amount of projections needs to be large as such. Increasing the amount of projections, however, increases the biting of the projections into the urethane layer, thus decreasing the rotation of the roller relative to the eccentric part of the crank rod. This decreases the finger pressure to the user, thus being not effective in recovering the sitter from fatigue.

In addition, in this type of massage mechanisms, the roller at the eccentric part moves between the foremost position and the rearmost position with the rotation of the crank rod; however, the location is fixed. Therefore, the roller pushes a specific part of the lumber or lower back of the sitter at regular intervals. Accordingly, there is a possibility that the sitter have pains as time passed, and besides, when the pushed part is out of a finger-pressure part desired by the sitter, the sitter is given an uncomfortable feeling.

### SUMMARY OF THE INVENTION

Accordingly, an object of the present invention is to solve the above related-art problems.

In order to solve the above problems, the present invention provides a seat with a massage mechanism including: a pair of brackets held on opposite sides of a base flame such that they can move vertically; a rod arranged rotatably relative to the brackets; and a push roller held rotatably by the rod in a position eccentric from the rotational shaft center of the rod.

With such a seat, the rotation of the rod moves the push rollers back and forth at regular intervals to give the sitter a massage like a finger pressure, and the vertical movement of the brackets changes the locations of the push rollers to give the sitter a massage in desired part.

Furthermore, the same advantages are also offered by a vehicle seat with a massage mechanism including: a pair of brackets held on opposite sides of a base flame such that they can move vertically by a driving mechanism held by a base frame; links supported so as to be swung relative to the brackets; a rod arranged rotatably relative to the brackets; an actuator for rotating the rod; and a pair of push rollers rotatably held by the rod in positions eccentric from the rotational shaft center of the rod. The rod moves vertically along guide sections and recessed sections on the opposite sides of the base frame. When located in the recessed sections, the rod is positioned in the rear relative to the flanges.

Preferably, a spring is disposed between each of the brackets and each of the links. The links are spring urged toward the opposite sides of the base frame. The seat is used as a vehicle seat.

Preferably, the rod is supported by the brackets through the links; the actuator for rotating the rod is held by one of the links, and the driving mechanism for vertically moving the brackets is held by the base frame.

The driving mechanism preferably includes an actuator and screw-nut mechanisms arranged along the opposite sides of the base frame and moving in synchronization with an output shaft of the actuator. Nuts of the screw-nut mechanisms are connected to the brackets.

According to an embodiment of the present invention, preferably, the opposite ends of the rod moves vertically along guide sections on the opposite sides of the base frame and the rod can be swung back an forth around the rotation center of the links.

In addition, preferably, the flanges sections on the opposite sides of the base frame have recessed sections recessed rearward relative to the seat. The rod may be in contact with the guide sections and the recessed sections serving as the front walls of the base frame through bushes.

More preferably, the opposite sides of the base frame each have a pair of first and second long holes extending vertically. The brackets are each connected to the nut of the screw-nut mechanism through the first long hole and are guided by the second long hole for the vertical movement.

The pair of push rollers is preferably arranged symmetrically with respect to the center of the base frame. The push rollers are rotatably supported by arms fixed to the rod.

### BRIEF DESCRIPTION OF THE DRAWINGS

FIG. 1 is a perspective view of the framework of a seat with a massage mechanism according to an embodiment of the present invention;

FIG. 2 is a perspective view of the details of a base frame according to an embodiment of the present invention;

FIG. 3 is a front view of the base frame according to an embodiment of the present invention;

FIG. 4 is a side view of the base frame in which a push roller is in the upper part thereof according to an embodiment of the present invention;

FIG. 5 is a side view of the base frame in which the push roller is in the lower part thereof according to an embodiment of the present invention;

FIG. 6 is a side view of the base frame in which the push roller is in the rear part thereof according to an embodiment of the present invention;

FIG. 7 is a side view of the base frame in which the push roller is in a recessed position according to an embodiment of the present invention;

FIG. 8 is a sectional view seen from the line VIII to VIII in FIG. 3, according to an embodiment of the present invention;

FIG. 9 is a sectional view seen from the line IX to IX in FIG. 3, according to an embodiment of the present invention;

FIG. 10 is a diagram showing the relationship between a pad layer of a seat and a human body (sitter) when the push roller is located as shown in FIGS. 4 and 5, according to an embodiment of the present invention; and

FIG. 11 is a diagram showing the relationship between a pad layer of a seat and a human body (sitter) when the push roller is located as shown in FIG. 7, according to an embodiment of the present invention.

### DESCRIPTION OF THE PREFERRED EMBODIMENTS

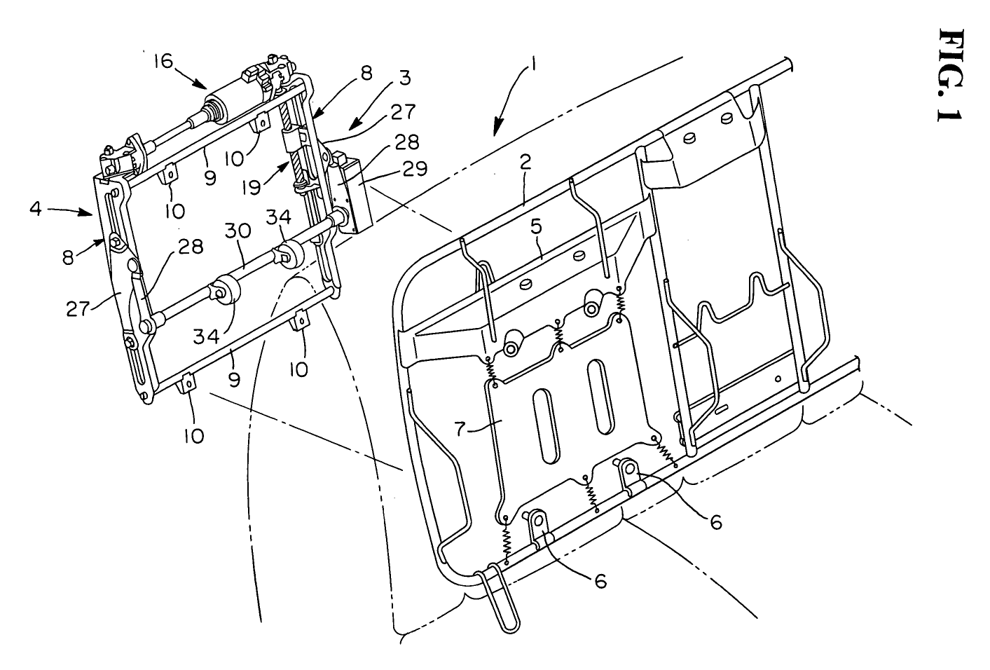

FIG. 1 shows a vehicle seat 1 incorporating an embodiment of the present invention. A base frame 4 of a massage mechanism 3 is fixed to a seat back frame 2 of the vehicle seat 1.

The seat back frame 2 is made of a pipe that is stamped into a rectangle. Brackets 5 and 6 are fixed to the seat frame 2, and the base frame 4 is fixed to the brackets 5 and 6 by a conventional way. A lumbar support 7 or a plurality of seat springs (not shown) is fixed to the seat frame 2. The vehicle seat 1 includes a pad layer formed of urethane and a skin, which are not shown in FIG. 1.

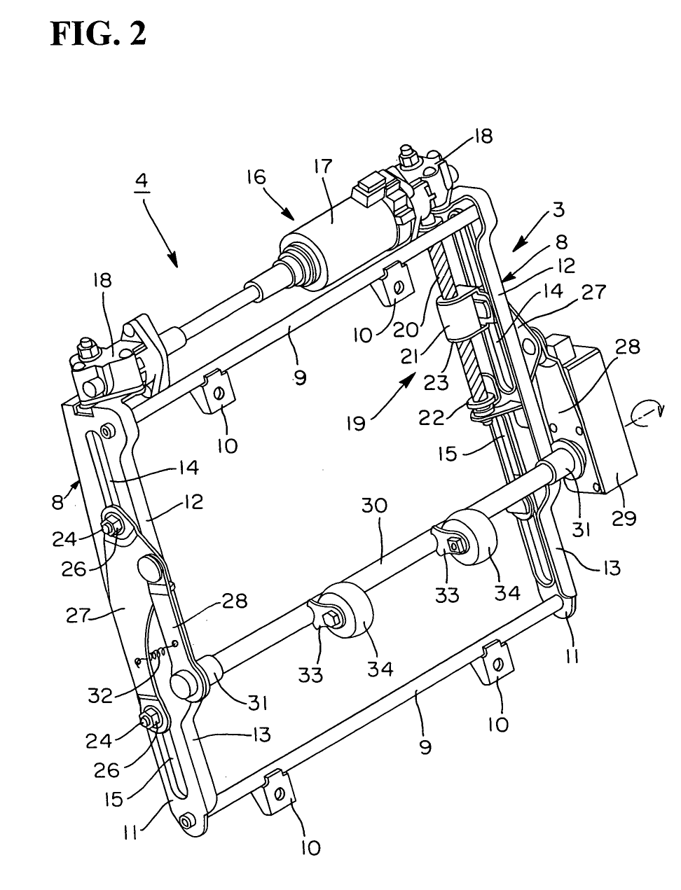

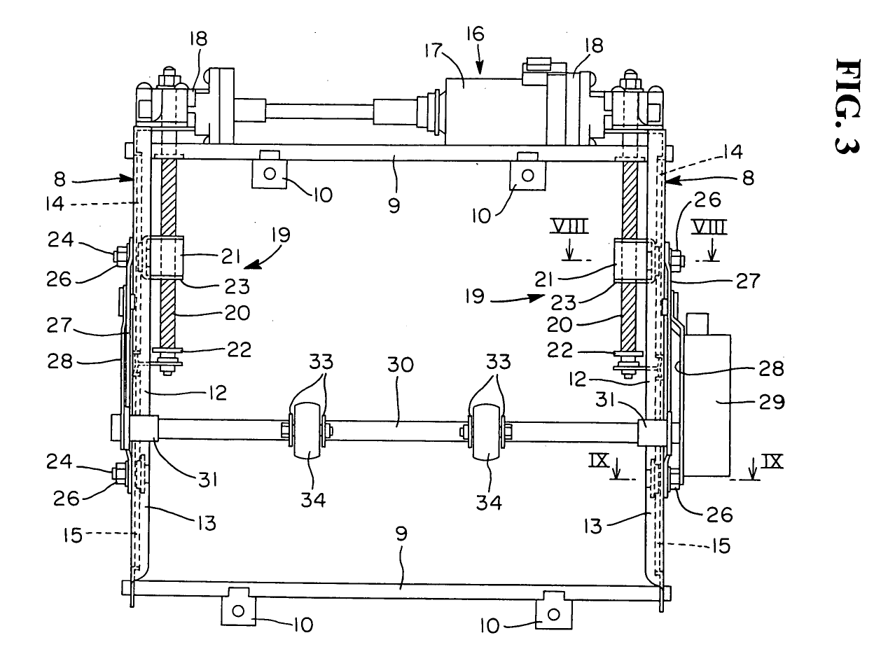

Referring to FIG. 2, the base frame 4 of the massage mechanism 3 is constructed of opposite sides 8 and two crossbars 9 connecting the opposite sides 8 at the upper and lower parts. Mounting members 10 for mounting to the brackets 5 and 6 of the seat frame 2 are fixed to the crossbars 9.

The opposite sides 8 are made of a stamped steel plate, each of which has a body 11 which extends vertically and a flange 12 serving as a front wall. The flange 12 has a recessed section 13 descending rearward at the lower part. The body 11 of the side 8 has a pair of long holes 14 and 15 extending along the length.

A driving mechanism 16 is mounted on the opposite sides 8. The driving mechanism 16 includes an electric motor 17 acting as an actuator, two reduction mechanisms 18, and two screw-nut mechanisms 19 connected to the reduction mechanisms 18 along the opposite sides 8 of the base frame 4.

Each of the screw-nut mechanisms 19 includes a screw 20 rotated by the reduction mechanism 18, a nut 21 screwed on the screw 20 and moving vertically with the rotation of the screw 20, and a stopper 22 for controlling the movement of the nut 21. The lower part of the screw 20 is supported by the side 8.

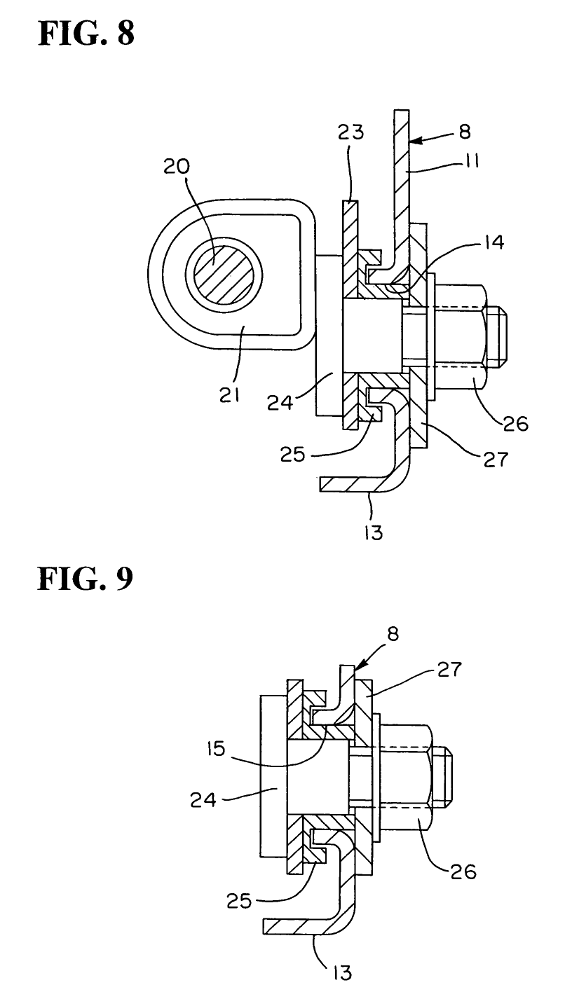

Referring to FIG. 8, the nut 21 to be screwed on the screw 20 is held by the side 8 with a bracket 23 for the nut 21, a bolt 24 to be fixed to the bracket 23, a slider 25 which slides along the long hole 14, and a nut 26 which is fastened on the bolt 24.

The slider 25 includes a hollow body passing through the long hole 14 and a bearing for receiving a flange at the side edge of the long hole 14, and the bolt 24 passes through the hollow part of the body.

A bracket 27 is disposed along the body 11 of the side 8. The bracket 27 is formed of a long plate, the upper part of which is held to the side 8 with the bolt 24.

Referring to FIG. 9, the lower part of the bracket 27 is held to the side 8 with the bolt 24, the slider 25, and the nut 26 such that it can be moved vertically by the guide of the long hole 15.

Referring again to FIG. 2, links 28 are each supported so as to be swung by the bracket 27 which moves vertically along the side 8 with the movement of the nut 21 along the screw 20. A first link 28 holds an actuator 29. A rod 30 is connected to the output shaft of the actuator 29.

The rod 30 extends between the opposite sides 8 and a second link 28 rotatably holds the end of the rod 30. Driving the actuator 29 rotates the rod 30.

Bushes 31 are connected to the opposite ends of the rod 30 and are each brought into slide contact with the flange 12 of the side 8. Both ends of a spring 32 are fixed to the link 28 and the bracket 27, by which the link 28 is spring-biased toward the flange 12 all the time. This eliminates the to-and-fro swing of the rod 30 during the vertical movement of the rod 30.

Two arms 33 are fixed to the rod 30, by which push rollers 34 are rotatably supported. Consequently, when the rod 30 is rotated, the push rollers 34 revolve around the rotation center of the rod 30 and rotate on their own axis at positions out of the rotation center of the rod 30. The motion of the push rollers 34 is a periodic to-and-fro motion, seen from the top in the drawing.

Although one push roller 34 is rotatably supported by one arm 33 in the drawing, two (at a distance of 180 degrees), or alternatively, three rollers 34 (at a distance of 120 degrees) may be supported. The push rollers 34 are arranged in pair on both sides of the center of the base frame 4. The push rollers 34 are preferably arranged on the both sides of the base frame 4 in bilateral symmetry.

The operation of the massage mechanism 3 according to an embodiment of the invention will now be described.

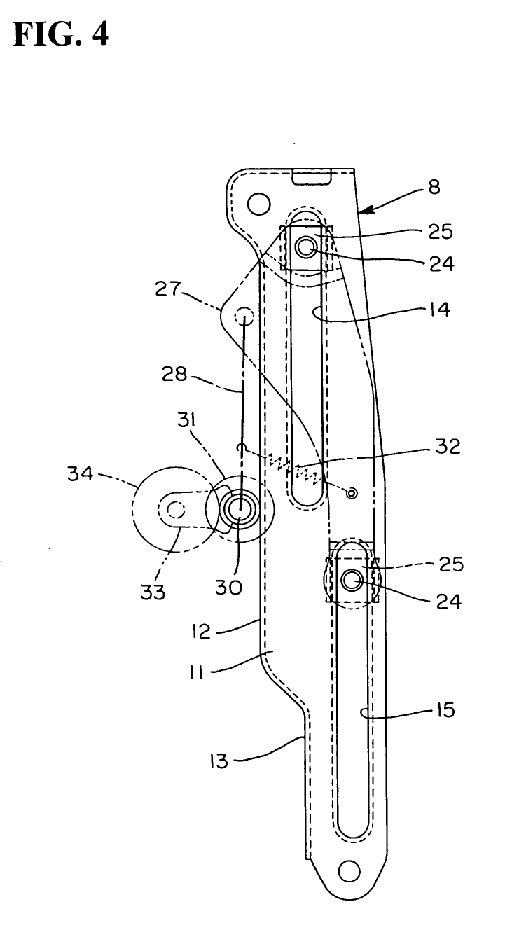

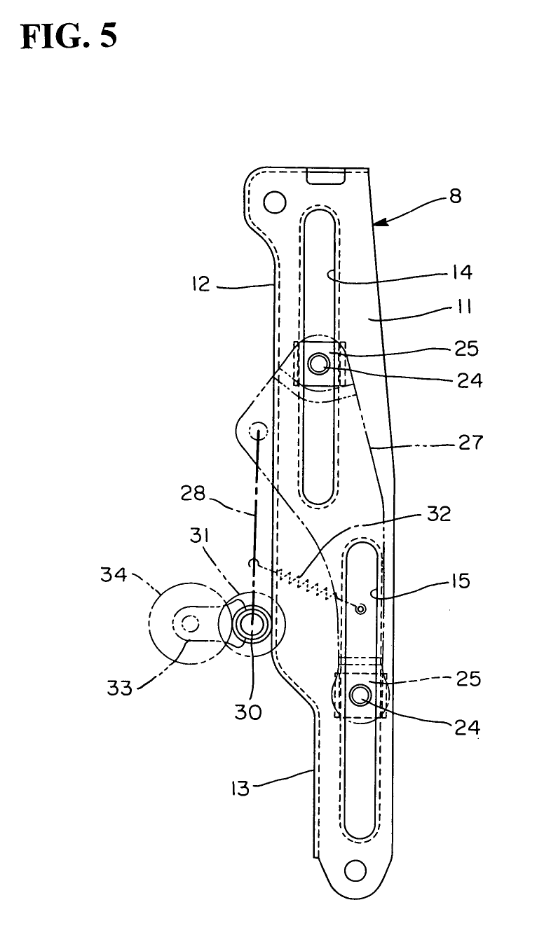

FIG. 4 shows the push rollers 34 in uppermost position. Refer to FIG. 5, when the sitter makes an instruction to lower the push rollers 34 with this state, the electric motor 17 is operated to rotate the screws 20, thereby moving the nuts 21 downward. The motion of each nut 21 is transmitted to the bracket 27, and so the bracket 27 moves downward with the motion of the nut 21.

Since the downward motion of the bracket 27 is guided by the sliders 25 and the long holes 14 and 15, the bracket 27 moves along a fixed locus. In addition, since the rod 30 is brought into contact with the flange 12 of the base frame 4, that is, the flanges 12 of the opposite sides of the base frame 4 through the bushes 31 by receiving the urging force of the springs 32 and the sitter's weight, the loci of the vertical motions of the push rollers 34 are also fixed as the loci of the vertical motions of the brackets 27.

When the push rollers 34 have reached positions desired by the sitter, the operation of the electric motor 17 is stopped. The actuator 29 is then driven to rotate the rod 30.

The rotation of the rod 30 revolves the push rollers 34 around the rotation center of the rod 30, thus applying finger pressure to the lower back or the like of the sitter. After the massage has been finished, the rotation of the rod 30 is stopped. If necessary, the push rollers 34 are moved in the rear.

A switch for the actuator 29 is preferably provided so that the sitter can select whether the push rollers 34 are located in the front or the rear while the rotation of the rod 30 is stopped. When the push rollers 34 are arranged in the rear, the weight of the sitter is received by the rod 30, so that the rod 30 acts as a lumbar support. The lumbar support 7 has preferably holes in appropriate positions, as shown in FIG. 1, through which the push rollers 34 are moved to and fro.

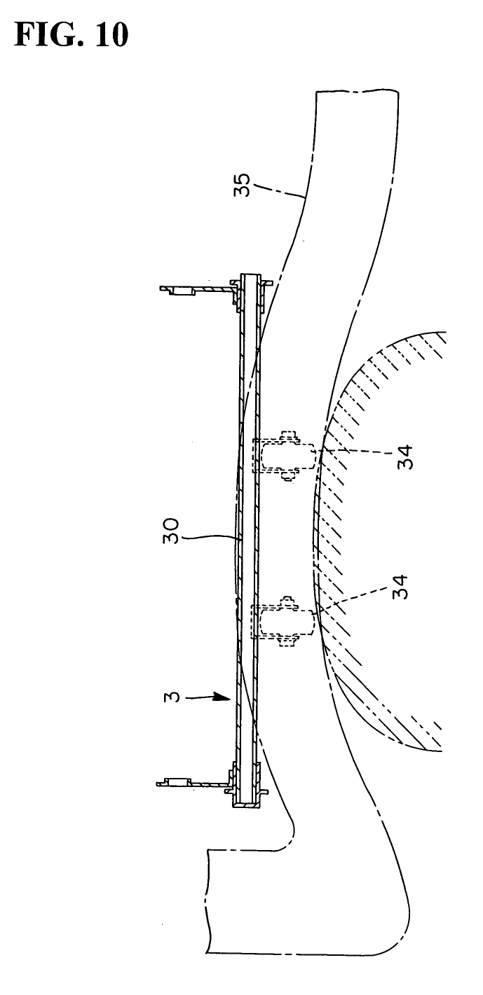

Referring to FIG. 10, the rod 30 pushes a pad layer 35 of the vehicle seat 1, which made of urethane, in the state of FIGS. 4 and 5, and the push rollers 34 push the lower back or the like of the sitter through the compressed pad layer 35, thereby applying finger pressure to the sitter.

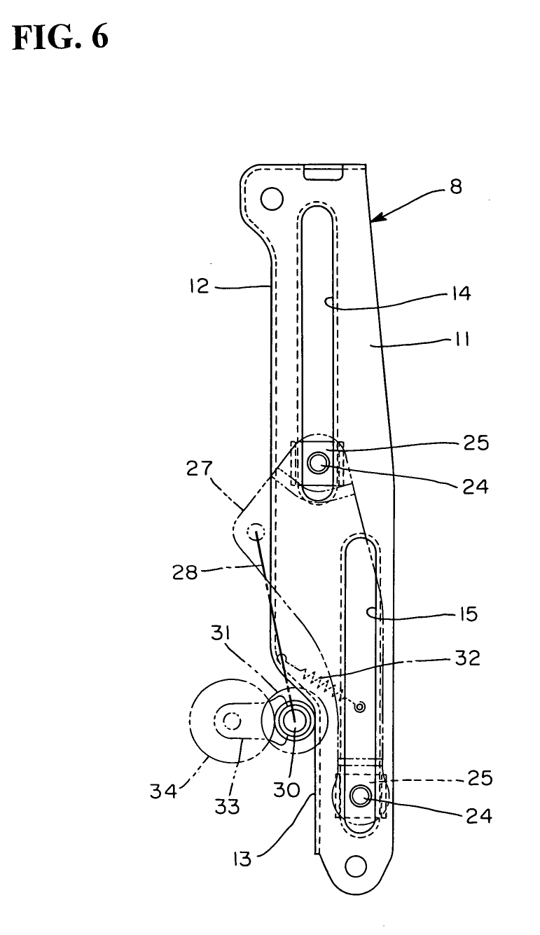

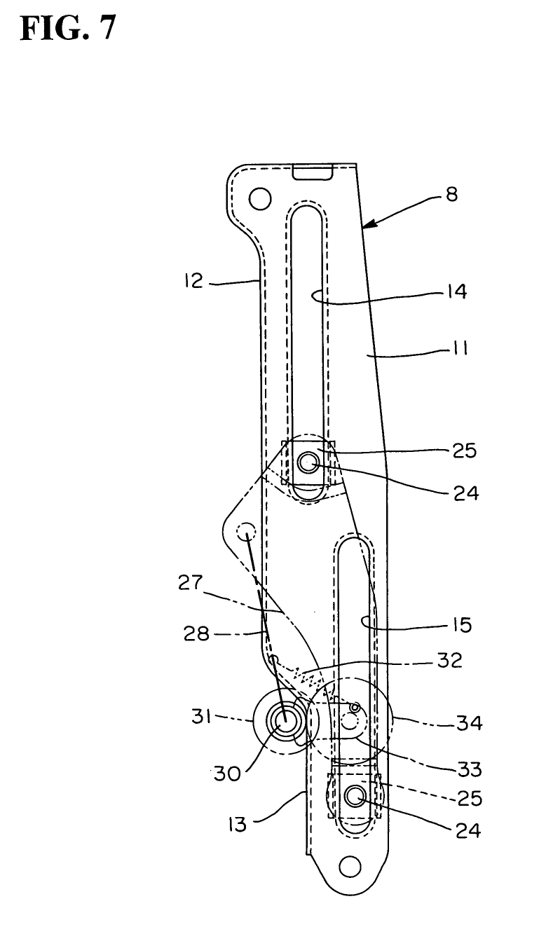

Refer to FIGS. 6 and 7. FIG. 6 shows a state in which the rod 30 and the push rollers 34 are moved into the recessed sections 13 on the opposite sides 8 of the base frame 4 with the electric motor 17 and the screw-nut mechanisms 19. Each of the recessed sections 13 is recessed backward from the flanges 12 by an amount slightly larger than the diameter of the bush 31. When the rod 30 moves from the flange 12 through a step to the recessed section 13, the rod 30 is positioned rearward relative to the flange 12.

The lowermost position of the rod 30 is restricted by the contact of the brackets 23 of the nuts 21 with the stoppers 22. The electric motor 17 stops automatically in this position, thus preventing overloading.

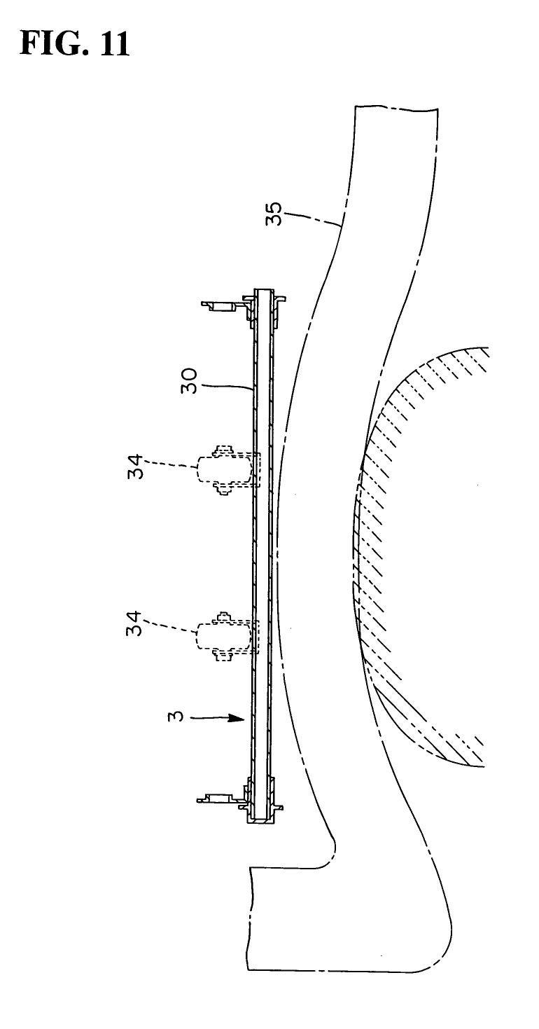

Although the push rollers 34 are at rest in the front in the state of FIG. 6, the sitter can also move the push rollers 34 in the rear to be at rest, as shown in FIG. 7, by the selection with the switch. In such a case, as shown in FIG. 11, the rod 30 is located behind the pad layer 35, so that the rod 30 and the push rollers 34 do not receive the weight of the sitter.

As clearly shown in FIGS. 4 to 7, the push rollers 34 can be freely moved vertically with a fixed locus by the motion of the rod 30 along the flanges 12 and the recessed sections 13. Accordingly, the push rollers 34 can be moved in positions desired by the sitter.

Furthermore, the rod 30 and the push rollers 34 can be moved to the recessed sections 13 in the rear relative to the flanges 12, or the front walls of the opposite sides 8 of the base frame 4. Thus, the sitter can use the seat without feeling the presence of the rod 30 and the push rollers 34. Consequently, the seat according to the invention is best suited for a vehicle seat.

In the drawings, the recessed sections 13 are arranged at the lower part of the flanges 12; however, they may be arranged in any other positions.

As many apparently widely different embodiments of the present invention can be made without departing from the spirit and scope thereof, it is to be understood that the invention is not limited to the specific embodiments thereof except as defined in the appended claims.

What is claimed is:

1. A seat with a massage mechanism comprising:
a pair of brackets held on opposite sides of a base flame such that they can move vertically;
a rod arranged rotatably relative to the brackets; and
a push roller held rotatably by the rod in a position eccentric from the rotational shaft center of the rod.

2. A seat with a massage mechanism according to claim 1, further comprising:
links connecting the rod with the brackets;
an actuator for rotating the rod; and
a driving mechanism for vertically moving the brackets;
wherein the rod is supported by the brackets through the links, the actuator is held by one of the links, and the driving mechanism is held by the base frame.

3. A seat with a massage mechanism according to claim 2,
wherein the driving mechanism comprises an actuator and screw-nut mechanisms arranged along opposite sides of the base frame and moving in synchronization with an output shaft of the actuator; wherein
nuts of the screw-nut mechanisms are connected to the brackets.

4. A seat with a massage mechanism according to claim 2, wherein opposite ends of the rod move vertically along guide sections on the opposite sides of the base frame and the rod can be swung back and forth around the rotation center of the links.

5. A seat with a massage mechanism according to claim 4, wherein the guide sections on the opposite sides of the base frame have recessed sections recessed backward relative to the seat.

6. A seat with a massage mechanism according to claim 5, wherein the rod is in contact with the guide sections and the recessed sections serving as the front walls of the base frame through bushes.

7. A seat with a massage mechanism according to claim 6,
wherein the opposite sides of the base frame each have a pair of first and second long holes extending vertically; and
wherein the brackets are each connected to the nut of the screw-nut mechanism through the first long hole and are guided by the second long hole for the vertical movement.

8. A seat with a massage mechanism according to claim 1, wherein the push rollers are arranged symmetrically with respect to the center of the base frame.

9. A seat with a massage mechanism according to claim 8, wherein the push rollers are rotatably supported by arms fixed to the rod.

10. A seat with a massage mechanism according to claim 9, wherein the arms each hold a plurality of the push rollers around the rotation center of the rod.

11. A seat with a massage mechanism according to claim 1, wherein the seat is a vehicle seat.

12. A seat with a massage mechanism according to claim 1, wherein the push roller exerts pressure on a pad layer of the seat for pushing the body part of a person sitting in the seat.

13. A seat with a massage mechanism comprising:
a pair of brackets held on opposite sides of a base flame such that they can move vertically by a driving mechanism held by a base frame;
links supported so as to be swung relative to the brackets;
a rod arranged rotatably relative to the brackets;
an actuator for rotating the rod; and
a pair of push rollers rotatably held by the rod in positions eccentric from the rotational shaft center of the rod;
wherein the rod moves vertically along guide sections and recessed sections on the opposite sides of the base frame; and when located in the recessed sections, the rod is positioned in the rear relative to the flanges.

14. A seat with a massage mechanism according to claim 13, further comprising a spring between each of the brackets and each of the links,
wherein the links are urged toward the opposite sides of the base frame.

15. A seat with a massage mechanism according to claim 13, wherein the seat is a vehicle seat.

16. A seat with a massage mechanism according to claim 13, wherein the push roller exerts pressure on a pad layer of the seat for pushing the body part of a person sitting in the seat.
